(19) United States
(12) Patent Application Publication
(10) Pub. No.: US 2021/0358035 A1
(43) Pub. Date: Nov. 18, 2021

(54) SYSTEMS AND METHODS FOR AUTOMATED MANIPULATION RESISTANT INDEXING

(71) Applicant: HDR SG PTE. LTD, Singapore (SG)

(72) Inventors: Bhavik Patel, Hong Kong (CN); Samuel Sandiford, Hong Kong (CN); Arthur Hayes, Hong Kong (CN)

(73) Assignee: HDR SG PTE. LTD, Prudential Tower (SG)

(21) Appl. No.: 17/316,517

(22) Filed: May 10, 2021

Related U.S. Application Data
(60) Provisional application No. 63/023,636, filed on May 12, 2020.

(51) Int. Cl. G06Q 40/04; G06Q 40/06; G06Q 30/02

(52) U.S. Cl. CPC G06Q 40/04; G06Q 30/0201; G06Q 30/0206; G06Q 40/06

(57) ABSTRACT

A system for automated manipulation resistant indexing is disclosed. The system may be configured to calculate a total prefilter trade volume of an historical trade data set based on a lookback coefficient, wherein the historical trade data set associated with a prefiltered exchange set, calculate a composition percentage of the total prefilter volume for each element of the prefiltered exchange set, apply a first filtering function based on the composition percentage to the prefiltered exchange set to generate a first filtered exchange set, normalize the first filtered exchange set based on the total prefilter trade volume to generate a first normalized exchange set, and generate a first weighting function based on the first normalized exchange set.

### CROSS REFERENCE TO RELATED APPLICATIONS

This application is a non-provisional of, claims priority to and benefit of, U.S. Provisional Application No. 63/023,636, filed May 12, 2020 and entitled “SYSTEMS AND METHODS FOR AUTOMATED MANIPULATION RESISTANT INDEXING,” which is incorporated by reference in its entirety.

### FIELD

This disclosure generally relates to financial instrument trading, and more particularly, to construction and use of cryptocurrency indices.

### BACKGROUND

Computers and computer software have long been used for accounting purposes. Accounting and closely monitoring the activity of price movements in tradable financial instruments is an integral part of any trading business. Indices structured based on the underlying cash market for the tradable financial instrument tend to provide useful insights for execution of real time trades. Traditionally, indices were composed by using equally weighted average algorithms. However, traditional composite indices tended to be vulnerable to manipulation. In this regard, the index price may be moved without a corresponding movement in the consensus price of the underlying market represented by the index.

### SUMMARY

A system, method, and computer readable medium (collectively, the “system”) is disclosed for automated manipulation resistant indexing. In various embodiments, the system calculate a total prefilter trade volume of an historical trade data set based on a lookback coefficient, wherein the historical trade data set associated with a prefiltered exchange set, calculate a composition percentage of the total prefilter volume for each element of the prefiltered exchange set, apply a first filtering function based on the composition percentage to the prefiltered exchange set to generate a first filtered exchange set, normalize the first filtered exchange set based on the total prefilter trade volume to generate a first normalized exchange set, and generate a first weighting function based on the first normalized exchange set.

In various embodiments, the system may receive a real time trade data set associated with the first normalized exchange set and apply the first weighting function to the real time trade data set to generate an index price for a currency pair. In various embodiments, the system may poll a real time trade data feed for each element of the real time trade data set, apply a second filtering function to the real time trade data feed to generate a filtered feed, and exclude the filtered feed from the real time trade data set to generate a first filtered real time data set.

In various embodiments, the system may generate a second weighting function based on the first filtered real time trade data set and apply the second weighting function to the real time trade data set to generate the index price for the currency pair. In various embodiments, the system may evaluate the filtered feed based on a re-inclusion criteria to determine a re-inclusion event, include the filtered feed with the first filtered real time data set in response to the re-inclusion event, and reapply the first weighting function to generate the index price for the currency pair based on the re-inclusion event. In various embodiments, the system may select a currency pair, determine an initial exchange set based on the currency pair, compare the initial exchange set to an exchange exclusion table to determine an excluded exchange set, and remove the excluded exchange set from the initial exchange set to generate the prefiltered exchange set.

In various embodiments, the system may generate a futures yield index based on a first futures contract price, a second futures contract price, and a third futures contract price of the real time trade data set, a front month expiration date, and a threshold date, calculate the futures yield index based on interpolation between the first futures contract price and the second futures contract price where the front month expiration date is greater than the threshold date, and calculate the futures yield index based on extrapolation of the second futures contract price and the third futures contract price where the front month expiration date is less than the threshold date.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

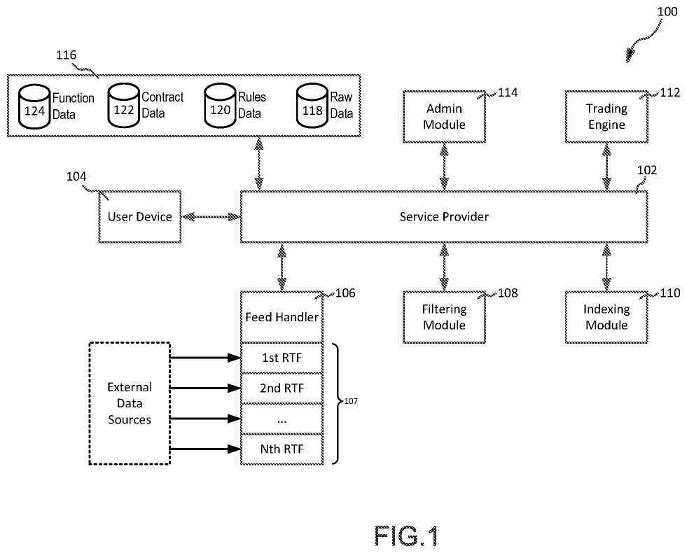

FIG. 1 is a block diagram illustrating a system for automated manipulation resistant indexing, in accordance with various embodiments;

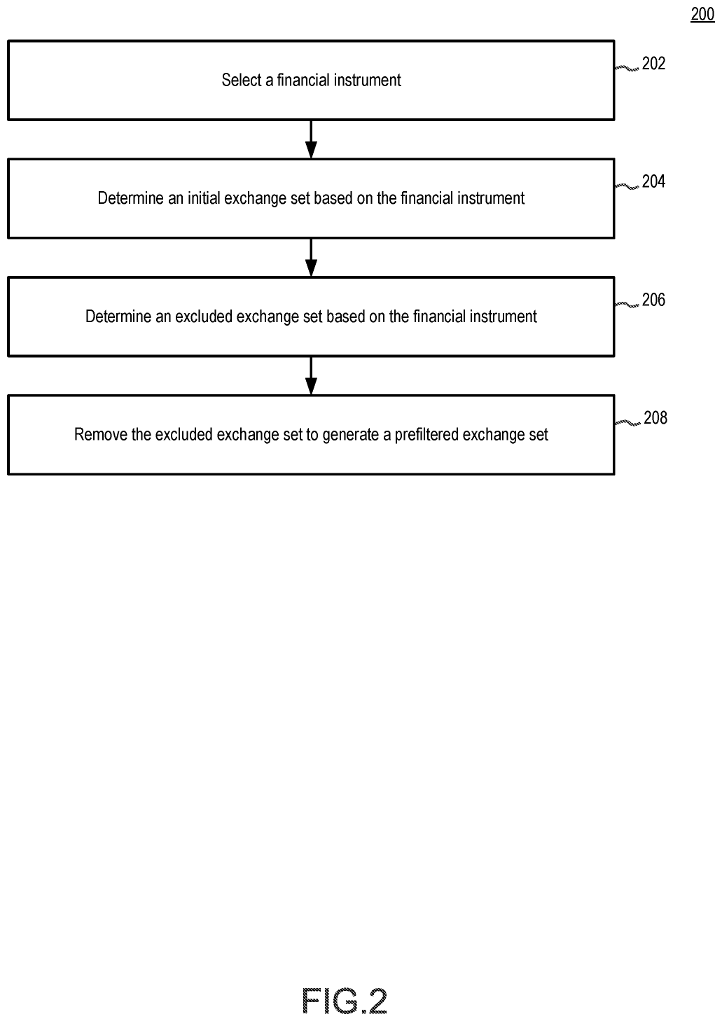

FIG. 2 illustrates a prefiltering process in a system for automated manipulation resistant indexing, in accordance with various embodiments;

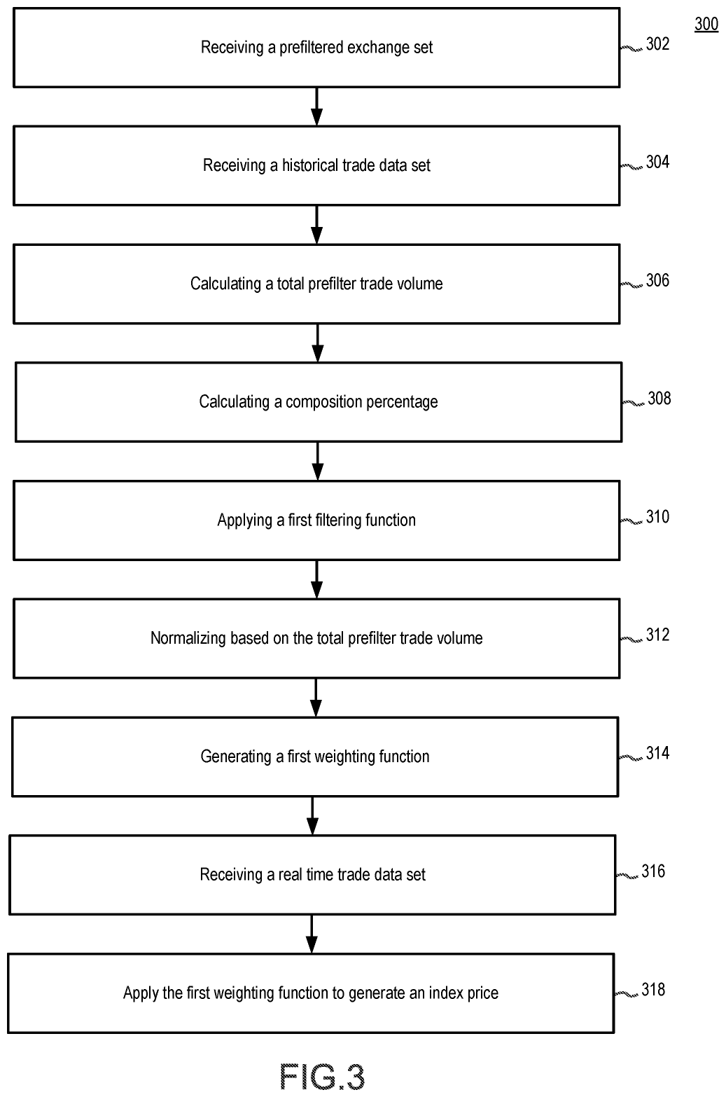

FIG. 3 illustrates a first index generation process in a system for automated manipulation resistant indexing, in accordance with various embodiments;

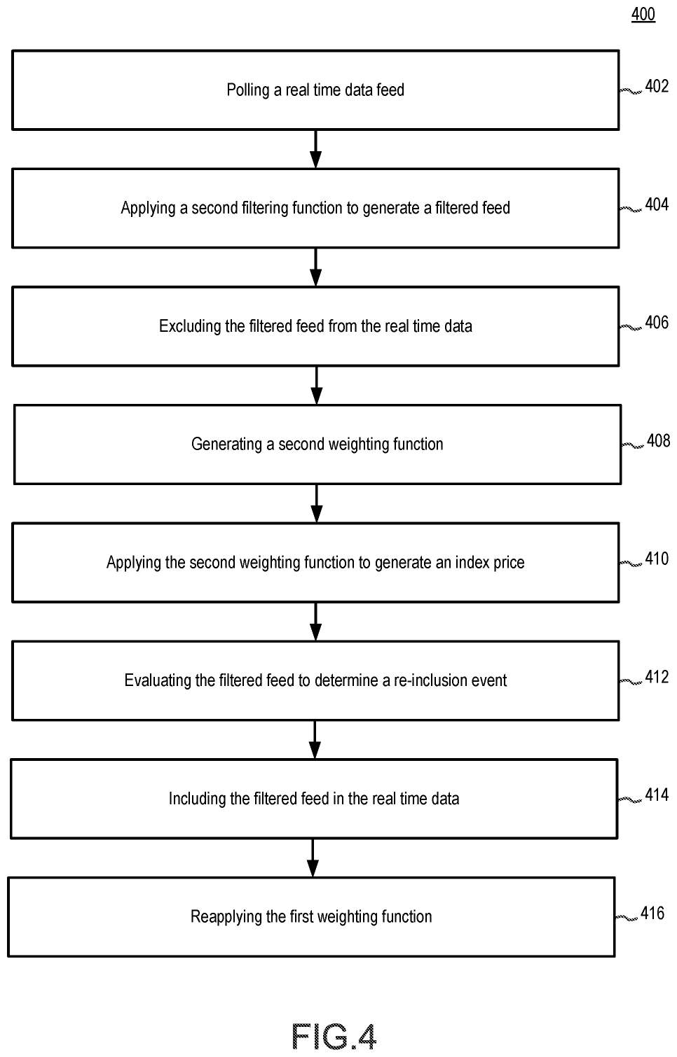

FIG. 4 illustrates a data filtering and validation process in a system for automated manipulation resistant indexing, in accordance with various embodiments; and

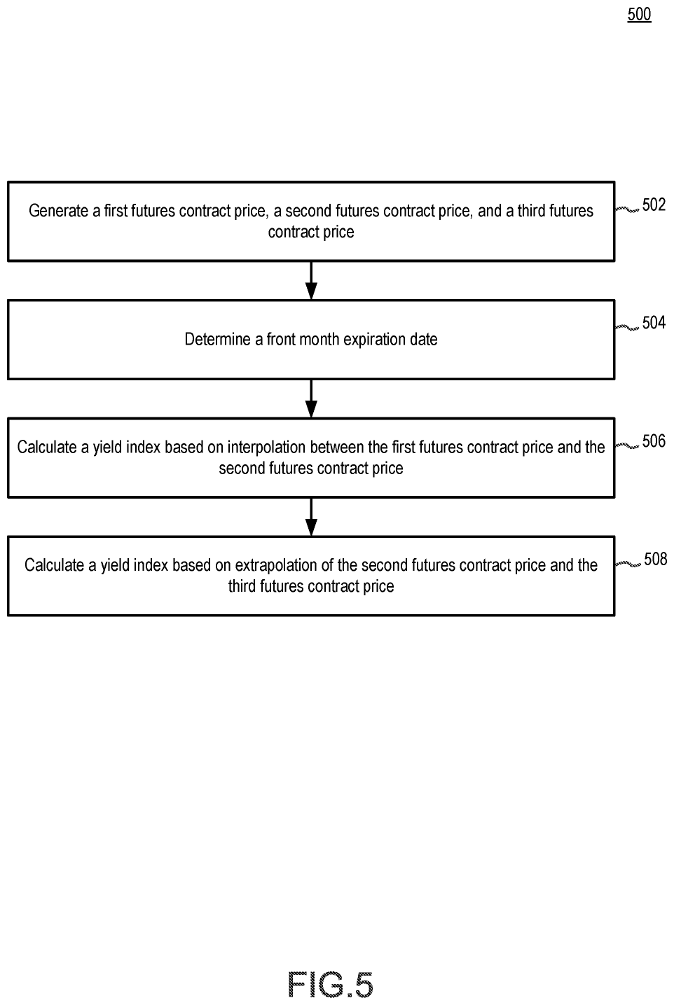

FIG. 5 illustrates a second index generation process in a system for automated manipulation resistant indexing, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The system may provide a greater level of sophistication and/or control for financial systems. For example, indexing tends to include highly regimented, semi-automated and/or manual processes. In that regard, customization of traditional indexing processes tends to be time consuming or inefficient for computational and operational resources. While prior art systems implement push architecture and tend to be relatively prone to manipulation, in various embodiments, the current system may incorporate multiple informational channels and multiple filtering processes, thereby tending to inhibit manipulation of index prices preferences. For example, filtering functions may identify manipulated feeds or unreliable feeds for removal from the index data set used to generate the index price and the system may automatically recalculate the index weights based on the post filtered data set.

In various embodiments, the system may eliminate or reduce index manipulation and improve index reliability, along with enabling enhanced automation features. The system may also reduce the cost of development, reduce system processing time for financial indexing, reduce network utilization, and/or reduce data storage overhead. The system may increase data reliability or accuracy by enabling data filtering functions and reliability testing. The system may also reduce a number of raw data sets for processing, thereby reducing a demand for system resources. The system may simplify data mining and enhance user experience by enabling immediate real time index normalization and weighting function generation. Benefits of the present disclosure may apply to any suitable trading environment. For example, the present disclosure may apply in equity trading, currencies trading, futures trading, and/or any other financial instrument, as well as in information analysis or fraud prevention contexts.

The systems and methods improve the functioning of the computer. For example, prefiltering raw data sources and implementing real time data quality monitoring increases processing efficiency. Similarly, the process increases the reliability and speed of data presentation by enabling real time regeneration of weighting functions. In various embodiments, an automated manipulation resistant indexing process model is enabled that increases the reliability and speed of index pricing. The system may periodically inject updates to the weighting function based on indicia of manipulation. The system may select from raw data feeds only those sources which are trusted and/or unlikely to be manipulated and may perform real time monitoring for indicia of manipulation. In this regard, by transmitting, storing, and/or accessing data using the processes described herein, the quality of the data is improved and errors are reduced. In various embodiments, the system may reduce processing times in comparison to real time trade volume weighted index systems. Such improvements also increase the efficiency of the network by accelerating trading, reducing a portion of duplicated processes, and reducing data outages. In various embodiments, prefiltering based on raw data risk reduction criteria may significantly reduce back end processing and reduce troubleshooting for component processes. In various embodiments, the processes may increase network availability by reducing front end and back end process calls. In this regard, the processes may save processing resources including CPU time, memory resources, and/or network resources.

With reference to FIG. 1, a system 100 for automated manipulation resistant indexing is depicted according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, system 100 may comprise an indexing service provider system 102 (i.e., service provider), a user device 104, a feed handler 106, a filtering module 108, an indexing module 110, a trading engine 112, an administration module 114, and a database module 116 (i.e., a database). Any of these components may be outsourced and/or be in communication with service provider 102 via a network. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. In various embodiments, service provider 102 may be configured as a central network element or hub to access various systems, engines, and components of system 100. Service provider 102 may comprise a network, computer-based system, and/or software components configured to provide an access point to various systems, engines, and components. Service provider 102 may be in operative and/or electronic communication with the user device 104, the feed handler 106, the filtering module 108, the indexing module 110, the trading engine 112, the administration module 114, and the database module 116. In this regard, the service provider 102 may allow communication from user device 104 and database module 116 to systems, engines, and components of system 100.

In various embodiments, user device 104 may comprise software and/or hardware in communication with the service provider 102 via a network comprising hardware and/or software configured to allow an account owner, an administrator, a user, a customer, and/or the like, access service provider 102. User device 104 may comprise any suitable device that is configured to allow a user to communicate with a network and the service provider 102. User device 104 may include, for example, a personal computer, personal digital assistant, cellular phone, kiosk, a mobile device, and/or the like and may allow a user to transmit voice communications and/or data.

In various embodiments, database module 116 may include any number of data structures or data elements such as raw data 118, rules data 120, contract data 122, and function data 124. Database module 116 may be configured to maintain raw data 118 such as, for example, data sets relating to exchange platform transactions such an exchange, a transaction type, a financial instrument, a currency, a price, a quantity, a date, a timestamp, a filtered feed, and/or the like. The raw data 118 may include metadata and system 100 performance data and event logs and/or the like. Database module 116 may be configured to maintain rules data 120 such as, for example, a filter set, a re-inclusion criteria, an exchange exclusion table, a currency pair, an excluded exchange set, a threshold date, and/or the like. Database module 116 may be configured to maintain contract data 122 such as, for example, a first futures contract price, a second futures contract price, and a third futures contract price, and/or the like. Database module 116 may be configured to maintain function data 124 such as, for example, data defining filtering functions, weighting functions, index price functions, and/or the like.

In various embodiments, the administration module 114 may include a GUI interface to the various systems, modules, and engines of system 100. Administration module 114 may be in operative and/or electronic communication with user device 104, the feed handler 106, the filtering module 108, the indexing module 110, the trading engine 112, the administration module 114, and the database module 116. In this regard, administration module 114 may allow communication from user device 104 to systems, engines, and components of system 100. In various embodiments, the administration module 114 may be configured to enable the manipulation of the rules data 120 and the function data 124.

In various embodiments, the trading engine 112 may comprise hardware or software configured to process transactions. The trading engine 112 may comprise or interact with an order book to match orders and execute transactions based on the matching orders. In various embodiments, the trading engine 112 may be configured to generate price data associated on a one to one basis with a financial instrument. For example, trading engine 112 may be configured to generate a first futures contract price, a second futures contract price, and a third futures contract price. The trading engine 112 may pass the price data to the feed handler or the indexing module as part of a real time trade data set.

In various embodiments, the feed handler 106 module is configured to process and capture a plurality of real time data feeds 107 from one or more external data sources. The feed handler 106 may store the captured data from the data feeds 107 as raw data 118 in the database module 116. In various embodiments, the external data sources may include a plurality of exchange platforms configured to execute transactions in financial instruments, fiat currencies, commodities, futures contracts, virtual currencies, and/or the like. In various embodiments, the feed handler 106 may be configured to process large data sets such as, for example, historical trade data or volume data from the external data sources.

Referring now to FIGS. 2-5, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 2-5, but also to the various system components as described above with reference to FIG. 1.

In various embodiments, and with reference to FIG. 2 a prefiltering process 200 of system 100 is illustrated. The system may select a financial instrument (step 202). In various embodiments, administration module 114 may receive a financial instrument set from the user device 104. The administration module 114 may store the financial instrument set as a table of rules data 120. In various embodiments, the indexing module 110 may select the financial instrument from the financial instrument table of the rules data 120. In various embodiments, the financial instrument may comprise one of an index, a stock, a bond, a derivative, a futures contract, a currency, a currency pair, and/or the like. In various embodiments, the currency pair may comprise any fiat currency and/or a virtual currency known to those skilled in the art. The fiat currency may comprise, for example, one of dollars, euros, pound sterling, won, yen, yuan, and/or the like. In various embodiments, the virtual currency may comprise one of reward points such as, for example, those associated with a reward program, coupons, credit cards, hotels, frequent flyer program, online services, and/or the like. In various embodiments, the virtual currency may comprise a token of or representation of a fiat currency, or a relatively closed currency such as, for example, a currency of a game economy. In various embodiments, the virtual currency includes cryptocurrencies which may be supported by a distributed ledger and/or blockchain network such as, for example, Bitcoin, ETHEREUM®, CARDANO®, Bitcoin Cash, EOS, Litecoin, Tron, Ripple, DASH™, Monero, and/or the like.

The system may determine an initial exchange set based on the financial instrument (step 204). For example, the indexing module 110 may select a currency pair from the financial instrument table of the rules data 120. The indexing module 110 may pass the selected currency pair to the filtering module 108. The filtering module 108 may determine an initial exchange set based on the currency pair. For example, the filtering module 108 may filter a table comprising a plurality of exchanges and associated financial instruments stored as raw data 118 to return the initial exchange set having elements associated on a one to one basis with the selected currency pair.

In various embodiments, the system may compare the financial instrument to an exchange exclusion table to determine an excluded exchange set (step 206). In various embodiments, the rules data 120 may include an exchange exclusion table. The exchange exclusion table may comprise a subset of the plurality of exchanges each associated with a set of financial instruments. In various embodiments, the exchange exclusion table may be generated by the administration module 114 and/or received by the system from the user device 104. In various embodiments, the exchange exclusion table comprises exchanges having data quality issues, bad practices, fraud issues, fictitious volume reporting, and/or the like. The filtering module 108 may lookup the selected currency pair in the exchange exclusion table to generate the excluded exchange set. In this regard, the system compares the currency pair to the exchange exclusion table to determine the excluded exchange set. The system may remove the excluded exchange set from the initial exchange set to generate a prefiltered exchange set (step 208). The system may thereby remove exchanges with known data quality issues, history of fraud, price manipulation, and/or the like.

In various embodiments and with additional reference to FIG. 3, a first index generation process 300 of system 100 is illustrated. The system may receive a prefiltered exchange set (step 302). In various embodiments, the prefilter exchange set may be generated as described with regard to process 200. In various embodiments the prefilter exchange set may be received from the user device 104 or generated by the administration module 114. The system may receive a historical trade data set associated with the prefiltered exchange data set (step 304). In various embodiments, the system may receive the historical trade data set from the user device 104 or from the feed handler 106. In various embodiments, the administration module 114 may generate the historical trade data set from the raw data 118 stored by feed handler 106 and based on the prefiltered exchange set of step 302. In this regard, the historical trade data set may comprise trade data for the selected financial instrument and associated with the exchanges comprising the prefiltered exchange set

The system may calculate a total prefilter trade volume of the historical trade data set based on a lookback coefficient (step 306). For example, the prefiltered exchange set may comprise an array of 30 exchanges and the system may sum the volume across the array over three months of prior trades. In this regard, the lookback coefficient may be a time window. In various embodiments, the lookback coefficient may be stored as rules data 120. The system may calculate a composition percentage of the total prefilter volume for each element of the prefiltered exchange set (step 308).

The system may apply a first filtering function to the prefiltered exchange set to generate a first filtered exchange set (step 310). In various embodiments, the first filtering function may comprise a configurable rules set defined by rules data 120. In various embodiments, the first filtering function may be based on the composition percentage calculated in step 308. For example, the first filtering function may be applied to the calculated composition percentages of each of the array of 30 exchanges a flag those where the composition percentage is less than a threshold value such as, for example, 2.5%. The system may remove those flagged exchanges from the array to generate the first filtered exchange set. For example, where 5 exchanges are flagged, the first filtered exchange set may comprise an array of 25 exchanges. In another example, a filtering function may be applied based on a time between trades selected by a lookback coefficient. For example, the times between consecutive trades for a given constituent exchange and symbol (i.e., financial instrument) may be ordered by the system and the exchange/symbol pair may be excluded if the 98^{th} percentile is greater than 15 minutes.

The system may normalize the first filtered exchange set based on the total prefilter trade volume to generate a first normalized exchange set (step 312). The system may generate a first weighting function based on the first normalized exchange set (step 314). In various embodiments, the system may store the first weighting function as function data 124. The system may receive a real time data set associated with the first normalized exchange set (step 316). In various embodiments, the real time data set may include price data associated with the selected financial instrument for each exchange. For example, a selected currency pair may be associated with prices for the selected currency pair across the array of exchanges. The system may apply the first weighting function to the real time trade data set to generate an index price for the selected financial instrument (step 318). For example, the indexing module 110 may apply the weighting function to the price array corresponding to the selected currency pair to generate the index price for the selected currency pair.

In various embodiments, the indexing module may apply a blended indexing function. The indexing module may apply the blended indexing function, for example, when the system determines the price data for the selected currency pair across the array of exchanges is unreliable. The system may determine whether the price data for the selected currency pair is unreliable based on the data filtering and validation process 400 described below. In response, the indexing module may substitute one or more alternative pairs to construct the index. For example, where the selected currency pair is BTC/USD, the indexing module may include a first BTC/USD constituent, a second BTC/USD constituent, a third BTC/USD constituent, and a fourth BTC/USD constituent to generate an initial index. In response to determining the third BTC/USD constituent and the fourth BTC/USD constituent unreliable, the system may substitute a first BTC/USDT and a second BTC/USDT pair both of which will be converted to USD via an index representing the USD/USDT pair. The indexing module may apply re-inclusion criteria as described in process 400 below. In response to determining the third BTC/USD constituent and the fourth BTC/USD constituent reliable, the indexing module may reinclude the selected pairs and exclude the alternative pairs. In various embodiments, the indexing module may include alternative pairs when the available constituents of the selected currency pair (after filtering) is five or less than five. In various embodiments, the indexing module may include alternative pairs when the available constituents of the selected currency pair (after filtering) is three or less than three. In various embodiments the alternative pairs selected by the indexing module may share one common currency.

In another example, the system may generate an initial index where the selected currency pair is ETH/USD. The indexing module may include a plurality of ETH/USD price sources each associated on a one-to-one basis with the exchanges of the array of exchanges to generate an initial index (e.g., a first ETH/USD constituent, a second ETH/USD constituent, a third ETH/USD constituent, a fourth ETH/USD constituent, and an Nth ETH/USD constituent). The system may monitor market trades in an alternative pairs such as ETH/USDT across the array of exchanges. In response to the ETH/USDT pair exceeding a volume threshold, the system may include the ETH/USDT alternative pair with the initial index set to generate the hybrid index.

In another example, the system may determine based on volume data that the market is fragmented. For example, the system may determine market volumes have moved (e.g., based on a volume threshold) from selected base pair (e.g., ETH/USD) toward an alternative pair (e.g., ETH/USDT). In response, the indexing module may generate a hybrid index comprising alternative pairs each of which may be valued against a third currency and represent at least 5% of observed volume on the associated exchange of the exchange array and/or the volume across the exchange array (e.g. an alternative pair volume threshold). In various embodiments the alternative pair volume threshold may be between 2% and 6%, or may be between 6% and 8%, or may be between 8% and 12%, or may be between 12% and 25%. The indexing module may include an ETH/USD constituent, an ETH/USDT constituent, an ETH/USDC constituent, an ETH/EUR constituent, and an ETH/BNB constituent. The indexing module may apply a conversion function to the alternative pair based on the third currency to generate the hybrid index. In various embodiments, the alternative pairs may include an interest rate pair which may be converted to currency terms. It will be appreciated by those skilled in the art that the system may substitute any number of alternative pairs for the selected currency pair. In various embodiments, as discussed below with regard to process 400, the system may recalculate, renormalize, and apply an alternative weighting functions in response to including the alternative pairs. The indexing module may exclude any of the alternative pairs in response to determining the alternative pair unreliable (i.e. by process 300 and process 400).

In various embodiments and with additional reference to FIG. 4, a data filtering and validation process 400 of system 100 is illustrated. The system may poll a Realtime data feed (step 402). In various embodiments, the feed handler 106 may poll a real time data feed for each element of the real time trade data set. For example, each of the plurality of real time data feeds 107 may be associated on a one to one basis with an exchange platform of the real time trade data set, or may be associated with one or more financial instruments, and/or the like. In various embodiments, each of the real time data feeds 107 may include real time trade data for the selected financial instrument. The system may apply a second filtering function to the real time data feed to generate a filtered feed (step 404).

In various embodiments, filtering module 108 may apply one or more data filtering functions (e.g., the first filtering function, a second filtering function, a third filtering function, etc.) to the raw data 118 captured by feed handler 106. In various embodiments, a filtering function comprises a configurable rules set defined by rules data 120. For example, filtering function may monitor elements of the real time data for stagnant elements and/or frames and a rule may be applied to flag each feed where an element of interest is static across a threshold number of frames or a threshold interval. For example, where volume element of a first real time data feed is static for more than four minutes or a price element is static between 60 data frames the first real time data feed may be flagged as a filtered feed. In another example, a filtering function may monitor one or more parameters of the first real time data feed associated with indicia of manipulation. The filtering module 108 may calculate a manipulation score based on the parameters associated with indicia of manipulation and may flag the first real time data feed as a filtered feed where the manipulation score exceeds a threshold. In another example, a volatility measurement of the a second real time data feed may exceed an upper bound or a lower bound defined by the rules data 120. In response, the filtering module 180 may flag the second real time data feed as a filtered feed. In another example, a price element of the first real time data feed deviates from a median deviation of the price elements associated with each of the second real time data feed, the third real time data feed, and the Nth real time data feed, the filtering module may flag the first real time data feed as a filtered feed. In another example, the system may flag a data feed as a filtered feed where a price discrepancy between the feeds exceeds 5% In another example, where a price element of a real time data feed deviates from a calculated index price, the real time data feed may be excluded. For example, where an index is calculated based on three or more real time data feeds if a constituent price differs from the median calculated index price by more than 25% the deviating feed may be excluded. In another example, the system may force the deviating to the last calculated index price. In another example, if an index is calculated based on a first real time data feed and a second real time data feed, where a price element differs from the median calculated index price by 12.5% the system may force the price element to the last calculated index price. Each filtering function may be stored by the system as function data 124. In this regard, a filter set comprising a plurality of filtering functions may be constructed by the administration module 114.

The system may exclude the filtered feed from the real time data set to generate a first fileted real time data set (step 406). In various embodiments, the system may apply one or more filtering functions simultaneously or in sequence to generate a plurality of filtered real time data sets (i.e., a second filtered real time data set, a third real time data set, etc.). In this regard, the first filtered real time data set (and, thereby, each subsequently filtered set) represents data which is validated for quality and filtered to inhibit manipulation of the associated index price. The system may generate a second weighting function based on the first filtered real time data set (step 408). In various embodiments, step 408 may include recalculating the composition percentage and renormalizing the first filtered real time data set as discussed with reference to steps 308-314 of process 300. In various embodiments, the system may store the second weighting function as function data 124. The system may apply the second weighting function to generate an index price (step 410). For example, the indexing module 110 may apply the second weighting function to the first filtered real time data set comprising price information for the selected financial instrument such as a currency pair. In various embodiments, the system may construct a weighting function based on historical lookback data. The indexing module may periodically recalculate a weighting function based on the historical data and apply the recalculated weighting function. In various embodiments, the weighting function may be recalculated based on a momentum tracker, a set of static weights, or dynamic weights.

The system may evaluate the filtered feed based on a re-inclusion criteria to determine a re-inclusion event (step 412). In various embodiments, the re-inclusion criteria may comprise a configurable rules set describing one or more re-inclusion events defined by rules data 120. In various embodiments, the re-inclusion criteria may be associated with corresponding filtering functions. For example, where a volatility measurement of a filtered feed lies within an upper volatility bound and a lower volatility bound for a time interval (e.g., at least 4 hours) then the system may determine the re-inclusion event. In another example, where a price element of a filtered feed lies within a threshold of the calculated median of the related feed price for a given time then the system may determine the re-inclusion event. For example, where the constituent price has remained within 2% of the median of the other constituent prices for a period of at least 15 minutes. In response, the system may include the filtered feed with the first filtered real time data set (step 414). In this regard, filtered feeds may be added back to the data set determinative of the index price. The system may reapply the first weighting function to generate the index price for the selected financial instrument based on the re-inclusion event (step 416). In this regard, the indexing module 110 may relate the weighting function to various sets of real time data feeds thereby tending to provide a more robust and accurate index price resistant to manipulation of the underlying data. In various embodiments, the system may display the index price via the user device 104.

In various embodiments and with additional reference to FIG. 5, a second index generation process of system 100 is illustrated. The system may generate a first futures contract price, a second futures contract price, and a third futures contract price (step 502). In various embodiments, each of the first futures contract price, second futures contract price, and third futures contract price may be generated by the trading engine 112. In various embodiments, the first futures contract price, second futures contract price, and third futures contract price may be extracted by the feed handler 106 from the real time data set. In various embodiments, the trading engine 112 may pass the real time data set to the feed handler 106 for extraction. The system may determine a front month expiration date (step 504). The system may calculate a futures yield index based on interpolation between the first futures contract price and the second futures contract price where the front moth expiration date is greater than a threshold date (step 506). The system may calculate the futures yield index based on extrapolation of the second futures contract price and the third futures contract price where the front month expiration date is less than the threshold date (step 508). In various embodiments, the threshold date may be configurable as rules data 120. For example, the threshold date may be 7 days from a current date. In this regard the indexing module 110 may apply the interpolation calculation where the front month is greater than 7 days from the current date. The indexing module 110 may then switch to the extrapolation calculation procedure when the front month is less than or equal to 7 days from the current date. Stated another way, the system may apply the algorithm as described as pseudocode below to determine the futures yield index:

Get C*1, C*2, and C*3 data where C*1 is a first futures contract, C*2 is a second futures contract, and C*3 is a third futures contract;

Set C1 and C2 as the first two futures contracts (out of C*1, C*2, C*3) with TimeToMaturity greater than 7 days;

Set [F1, F2]=LastPrice of [C1, C2];

Set [D1, D2]=CurrentDay−DeliveryDate [C1, C2];

Set S=SpotIndex [C1, C2]; // the underlying spot index related to the futures contract settlement, may be a time weighted average

Fs=F1+(F2−F1)*(90−D1)/(D2−D1);

YieldIndex=((Fs/S)−1)/(90/365).

In various embodiments, the system may execute a transaction based on the future yield index and/or the index price generated by processes 300, 400, and 500. The system may display the index price via the user device 104. The system may receive a transaction request from the user device 104 associated with the index price. The trading engine 112 may execute the transaction in response to the transaction request. In various embodiments, the system may receive a transaction request including a threshold value from the user device 104. The trading engine 112 may execute a transaction in response to the index price exceeding a threshold value. In response to executing the transaction, the system may update a user account. For example, the trading engine 112 may transfer a number of financial instruments from a first user account to a second user account. For example, the system may record a first user account as a ‘seller’ and a second user account as a ‘buyer’. In this regard, the system may execute the transaction.

In various embodiments, the financial instruments may be a futures contract representative of a promise to deliver on a delivery date a quantity of a cryptocurrency at a contract price. The system may, on the delivery date, transfer the quantity of cryptocurrency from a first wallet associated with the first user account to a second wallet associated with the second user account. In various embodiments, the system may perform a conversion of a financial instrument (e.g., a cryptocurrency, a bond, a futures contract, a stock, etc.) to a fiat currency. For example, the system may convert a cryptocurrency to a fiat currency or may enable the user to transfer the cryptocurrency to any number of merchants. In this regard, the system may enable a user to purchase goods and services using the financial instrument. In various embodiments, the trading engine 112 may use one or more index prices to calculate related mark prices. The system may determine PnL of a user account based on the mark price. In various embodiments, the system may determine a liquidation event based on the PnL and, in response to the liquidation event, may liquidate the related account. For example, the liquidation event may be determined where an unrealized PnL is negative by more than an available margin associated with the user account. In various embodiments, the index generation systems and methods discussed herein may be applied to all manner of future financial products such as, for example, futures, options, certificates, ETFs, structured notes, warrants, loans, bonds, and/or the like. The system may interface with third party systems and provide data to the third party such as, for example, the index price and/or the futures yield index price.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

As used herein, “match,” “associated with”, or similar phrases may include an identical match, a partial match, meeting certain criteria, matching a subset of data, a correlation, satisfying certain criteria, a correspondence, an association, an algorithmic relationship, and/or the like. Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, OZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

A “consumer profile” or “consumer profile data” may comprise any information or data about a consumer that describes an attribute associated with the consumer (e.g., a preference, an interest, demographic information, personally identifying information, and the like).

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

As used herein, the term “end user,” “consumer,” “customer,” “cardmember,” “business,” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

The customer may be identified as a customer of interest to a merchant based on the customer's transaction history at the merchant, types of transactions, type of transaction account, frequency of transactions, number of transactions, lack of transactions, timing of transactions, transaction history at other merchants, demographic information, personal information (e.g., gender, race, religion), social media or any other online information, potential for transacting with the merchant, and/or any other factors.

Phrases and terms similar to “business” or “merchant” may be used interchangeably with each other and shall mean any person, entity, distributor system, software, and/or hardware that is a provider, broker, and/or any other entity in the distribution chain of goods or services. For example, a merchant may be a grocery store, a retail store, a travel agency, a service provider, an on-line merchant, or the like.

The disclosure and claims do not describe only a particular outcome of a system for automated manipulation resistant indexing, but the disclosure and claims include specific rules for implementing the outcome of a system for automated manipulation resistant indexing and that render information into a specific format that is then used and applied to create the desired results of a system for automated manipulation resistant indexing, as set forth in McRO, Inc. v. Bandai Namco Games America Inc. (Fed. Cir. case number 15-1080, Sep. 13, 2016). In other words, the outcome of a system for automated manipulation resistant indexing can be performed by many different types of rules and combinations of rules, and this disclosure includes various embodiments with specific rules. While the absence of complete preemption may not guarantee that a claim is eligible, the disclosure does not sufficiently preempt the field of a system for automated manipulation resistant indexing at all. The disclosure acts to narrow, confine, and otherwise tie down the disclosure so as not to cover the general abstract idea of just a system for automated manipulation resistant indexing. Significantly, other systems and methods exist for a system for automated manipulation resistant indexing, so it would be inappropriate to assert that the claimed invention preempts the field or monopolizes the basic tools of a system for automated manipulation resistant indexing. In other words, the disclosure will not prevent others from a system for automated manipulation resistant indexing, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

What is claimed is:

1. A method comprising:
calculating, by a computer based system, a total prefilter trade volume of an historical trade data set based on a lookback coefficient, wherein the historical trade data set is associated with a prefiltered exchange set;
calculating, by the computer system, a composition percentage of the total prefilter volume for each element of the prefiltered exchange set;
applying, by the computer based system, a first filtering function to the prefiltered exchange set to generate a first filtered exchange set, wherein the first filtering function is based on the composition percentage;
normalizing, by the computer based system, the first filtered exchange set based on the total prefilter trade volume to generate a first normalized exchange set; and
generating, by the computer based system, a first weighting function based on the first normalized exchange set.

2. The method of claim 1, further comprising:
receiving, by the computer based system, a real time data set associated with the first normalized exchange set; and
applying, by the computer based system, the first weighting function to the real time data set to generate an index price for a currency pair.

3. The method of claim 2, further comprising:
polling, by the computer based system, a real time data feed for each element of the real time data set;
applying, by the computer based system, a second filtering function to the real time data feed to generate a filtered feed; and
excluding, by the computer based system, the filtered feed from the real time data set to generate a first filtered real time data set.

4. The method of claim 3, further comprising:
generating, by the computer based system, a second weighting function based on the first filtered real time data set; and
applying, by the computer based system, the second weighting function to the real time data set to generate the index price for the currency pair.

5. The method of claim 4, further comprising:
evaluating, by the computer based system, the filtered feed based on a re-inclusion criteria to determine a re-inclusion event;
including, by the computer based system, the filtered feed with the first filtered real time data set, in response to the re-inclusion event; and
reapplying, by the computer based system, the first weighting function to generate the index price for the currency pair based on the re-inclusion event.

6. The method of claim 1, further comprising:
selecting, by the computer based system, a currency pair;
determining, by the computer based system, an initial exchange set based on the currency pair;
comparing, by the computer based system, the currency pair to an exchange exclusion table to determine an excluded exchange set; and
removing, by the computer based system, the excluded exchange set from the initial exchange set to generate the prefiltered exchange set.

7. The method of claim 2, further comprising
generating, by the computer based system, a first futures contract price, a second futures contract price, and a third futures contract price from the real time data set
determining, by the computer based system, a front month expiration date;
calculating, by the computer based system, a futures yield index price based on interpolation between the first futures contract price and the second futures contract price where the front month expiration date is greater than a threshold date; and
calculating, by the computer based system, the futures yield index based on extrapolation of the second futures contract price and the third futures contract price, wherein the front month expiration date is less than the threshold date.

8. A computer-based system, comprising:
a processor; and
a tangible, non-transitory memory configured to communicate with the processor, the tangible, non-transitory memory having instructions stored thereon that, in response to execution by the processor, cause the processor to perform operations comprising:
calculating, by the processor, a total prefilter trade volume of an historical trade data set based on a lookback coefficient, wherein the historical trade data set is associated with a prefiltered exchange set;
calculating, by the processor, a composition percentage of the total prefilter volume for each element of the prefiltered exchange set;
applying, by the processor, a first filtering function to the prefiltered exchange set to generate a first filtered exchange set, wherein the first filtering function is based on the composition percentage;
normalizing, by the processor, the first filtered exchange set based on the total prefilter trade volume to generate a first normalized exchange set; and
generating, by the processor, a first weighting function based on the first normalized exchange set.

9. The computer based system of claim 8, wherein the operations further comprise:
receiving, by the processor, a real time data set associated with the first normalized exchange set; and
applying, by the processor, the first weighting function to the real time data set to generate an index price for a currency pair.

10. The computer based system of claim 9, wherein the operations further comprise:
polling, by the processor, a real time data feed of the real time data set;
applying, by the processor, a second filtering function to the real time data feed to generate a filtered feed; and
excluding, by the processor, the filtered feed from the real time data set to generate a first filtered real time data set.

11. The computer based system of claim 10, wherein the operations further comprise:
generating, by the processor, a second weighting function based on the first filtered real time data set; and
applying, by the processor, the second weighting function to the real time data set to generate the index price for the currency pair.

12. The computer based system of claim 11, wherein the operations further comprise:
evaluating, by the processor, the filtered feed based on a re-inclusion criteria to determine a re-inclusion event;
including, by the processor, the filtered feed with the first filtered real time data set in response to the re-inclusion event; and
reapplying, by the processor, the first weighting function to generate the index price for the currency pair based on the re-inclusion event.

13. The computer based system of claim 8, wherein the operations further comprise:
selecting, by the processor, a currency pair;
determining, by the processor, an initial exchange set based on the currency pair;
comparing, by the processor, the currency pair to an exchange exclusion table to determine an excluded exchange set; and
removing, by the processor, the excluded exchange set from the initial exchange set to generate the prefiltered exchange set.

14. The computer based system of claim 9, wherein the operations further comprise:
generating, by the processor, a first futures contract price, a second futures contract price, and a third futures contract price from the real time data set
determining, by the processor, a front month expiration date;
calculating, by the processor, a futures yield index based on interpolation between the first futures contract price and the second futures contract price where the front month expiration date is greater than a threshold date; and
calculating, by the processor, the futures yield index based on extrapolation of the second futures contract price and the third futures contract price, wherein the front month expiration date is less than the threshold date.

15. An article of manufacture including a non-transitory, tangible computer readable storage medium having instructions stored thereon that, in response to execution by a computer based system, cause the computer based system to perform operations comprising:
calculating, by the computer based system, a total prefilter trade volume of an historical trade data set based on a lookback coefficient, wherein the historical trade data set is associated with a prefiltered exchange set;
calculating, by the computer system, a composition percentage of the total prefilter volume for each element of the prefiltered exchange set;
applying, by the computer based system, a first filtering function to the prefiltered exchange set to generate a first filtered exchange set, wherein the first filtering function is based on the composition percentage;
normalizing, by the computer based system, the first filtered exchange set based on the total prefilter trade volume to generate a first normalized exchange set; and
generating, by the computer based system, a first weighting function based on the first normalized exchange set.

16. The article of manufacture of claim 15, wherein the operations further comprise:
receiving, by the computer based system, a real time data set associated with the first normalized exchange set; and
applying, by the computer based system, the first weighting function to the real time data set to generate an index price for a currency pair.

17. The article of manufacture of claim 16, wherein the operations further comprise:
polling, by the computer based system, a real time data feed of the real time data set;
applying, by the computer based system, a second filtering function to the real time data feed to generate a filtered feed;
excluding, by the computer based system, the filtered feed from the real time data set to generate a first filtered real time data set;
generating, by the computer based system, a second weighting function based on the first filtered real time data set; and
applying, by the computer based system, the second weighting function to the real time data set to generate the index price for the currency pair.

18. The article of manufacture of claim 17, wherein the operations further comprise:
evaluating, by the computer based system, the filtered feed based on a re-inclusion criteria to determine a re-inclusion event;
including, by the computer based system, the filtered feed with the first filtered real time data set in response to the re-inclusion event; and
reapplying, by the computer based system, the first weighting function to generate the index price for the currency pair based on the re-inclusion event.

19. The article of manufacture of claim 15, wherein the operations further comprise:
selecting, by the computer based system, a currency pair;
determining, by the computer based system, an initial exchange set based on the currency pair;
comparing, by the computer based system, the initial exchange set to an exchange exclusion table to determine an excluded exchange set; and
removing, by the computer based system, the excluded exchange set from the initial exchange set to generate the prefiltered exchange set.

20. The article of manufacture of claim 16, wherein the operations further comprise:
generating, by the computer based system, a first futures contract price, a second futures contract price, and a third futures contract price from the real time data set
determining, by the computer based system, a front month expiration date;
calculating, by the computer based system, a futures yield index based on interpolation between the first futures contract price and the second futures contract price where the front month expiration date is greater than a threshold date; and
calculating, by the computer based system, the futures yield index based on extrapolation of the second futures contract price and the third futures contract price, wherein the front month expiration date is less than the threshold date.
